(19) United States
(12) Patent Application Publication
(10) Pub. No.: US 2025/0360941 A1
(43) Pub. Date: Nov. 27, 2025

(54) Spatial Localization Imaging System

(71) Applicant: Caterpillar Inc., Peoria, IL (US)

(72) Inventors: Bradley Paul Krone, Dunlap, IL (US); Christopher Michael Gerth, Chillicothe, IL (US)

(73) Assignee: Caterpillar Inc., Peoria, IL (US)

(21) Appl. No.: 18/670,462

(22) Filed: May 21, 2024

(51) Int. Cl. B60W 60/00; G01C 21/30

(52) U.S. Cl. CPC B60W 60/001; G01C 21/30; B60W 2300/17

(57) ABSTRACT

A spatial localization imaging system for a machine, including an imaging device mounted to a frame of the machine, a target configured to interact with the imaging device, and a controller operatively connected to an implement of the machine, the controller configured to receive target data from the imaging device, interpret the target data to calculate a map of a site the machine is operating on, provide a real-time estimate of a location of the machine within the site, and provide an automated input for the implement.

### TECHNICAL FIELD

The present disclosure generally relates to work machines, and more particularly relates to spatial localization systems for work machines.

### BACKGROUND

Mobile work machines may be used in the heavy industries such as earth moving, mining, construction, and the like to move portions of a ground surface, transport materials and personnel. These work machines are often large in size, and require an operator, e.g., a driver, to manually operate the machine in order for the machine to perform its designated/intended operations.

Certain work machines, such as bulldozers, use implements to perform various tasks on a work site. These implements may be required to transfer heavy loads, and as such, may utilize hydraulic systems to aid in operating mechanisms for the implements. Specifically with earth moving machines, the implement may be a blade for cutting into the ground surface and moving large sections of dirt in order to create a specific grade on a large area.

Knowing the machine's position on the jobsite while the machine is being operated is important for accurate blade positioning relative the machine to move the optimum quantity of dirt with precision. In the past, global positioning system (GPS) technologies have been used to monitor the location of the machine. While useful, GPS systems often lack precise accuracy, are too expensive to deploy to small construction sites, and have trouble being used in an indoor environment.

U.S. Pat. No. 9,481,982 discloses a method for generating scaled terrain information while operating a bulldozer. The bulldozer may include a driving unit comprising a set of drive wheels, a motor connected to at least one of the drive wheels, a blade for altering the surface of the terrain, at least one camera for capturing images of the environment, the camera being positioned and aligned in a known manner relative to the bulldozer, and a controlling and processing unit. A method may include moving the bulldozer while concurrently generating a set of image data by capturing an image series of terrain sections with the at least one camera so that at least two images of the image series cover an amount of identical points in the terrain, and either applying a simultaneous localization and mapping (SLAM) algorithm or a stereo photogrammetry algorithm to the set of image data and thereby deriving terrain data.

In light of the aforementioned shortcomings, there is a need for a system for accurately localizing a machine on a job site in real-time.

### SUMMARY OF THE DISCLOSURE

In accordance with one aspect of the disclosure, a machine may be provided. The machine may comprise a frame, an engine supported by the frame, and a drivetrain connected to the engine, the drivetrain connected to a ground engaging member. The machine may comprise an operator cabin supported by the frame, and a controller mounted within the operator cabin for controlling operation of the machine. The machine may comprise an implement operatively associated with the frame, the implement movable relative to the frame and controlled by the controller. The machine may comprise an imaging device mounted to the machine, the imaging device configured to interact with a target of a spatial localization imaging system and deliver target data to the controller. The controller may be configured to interpret the target data to calculate a map of a site the machine is operating on, provide a real-time estimate of a location of the machine within the site, and provide an automated input for the implement.

In accordance with another aspect of the disclosure, a spatial localization imaging system for a machine may be provided. The spatial localization imaging system may comprise an imaging device mounted to the machine. The spatial localization imaging system may comprise a target configured to interact with the imaging device. The spatial localization imaging system may comprise a controller operatively connected to an implement of the machine, the controller configured to receive target data from the imaging device, interpret the target data to calculate a map of a site the machine is operating on, provide a real-time estimate of a location of the machine within the site, and provide an automated input for the implement.

In accordance with yet another aspect of the disclosure, a method of spatial localization of a machine on a site may be provided. The method may comprise providing the machine including a frame, an implement attached to the frame and movable relative to the frame, an operator cabin supported by the frame, and a controller mounted within the operator cabin for controlling operation of the machine. The method may comprise providing an imaging device mounted to the machine and configured to communicate with the controller, and providing the site with a target configured to interact with the imaging device. The method may comprise operating the machine to a starting point on the site, commanding establishment of an origin through the controller, capturing a target data of the target through interaction with the imaging device and sending the target data from the imaging device to the controller, and generating a map of the site. The method may comprise estimating a real-time location of the machine on the site, based on the map, and automating a positioning of the implement relative to the frame.

These and other aspects and features of the present disclosure will be more readily understood when read in conjunction with the accompanying drawings.

### BRIEF DESCRIPTION OF THE DRAWINGS

FIG. 1 is a perspective view of a machine constructed in accordance with an embodiment of the present disclosure.

FIG. 2 is a perspective view of a target of a spatial localization imaging system constructed in accordance with an embodiment of the present disclosure.

FIG. 3 is a perspective view of a target of a spatial localization imaging system constructed in accordance with an embodiment of the present disclosure.

FIG. 4 is a topographical view of a site on which a machine utilizing a spatial localization imaging system operates, constructed in accordance with an embodiment of the present disclosure.

FIG. 5 is a flowchart depicting a sample sequence of steps for spatial localization of a machine on a site, which may be practiced in accordance with the work machine of the present disclosure.

The figures depict one embodiment of the presented invention for purpose of illustration only. One skilled in the art will readily recognize form the following discussion that alternative embodiments of the structures and method illustrated herein may be employed without departing form the principles described herein.

### DETAILED DESCRIPTION

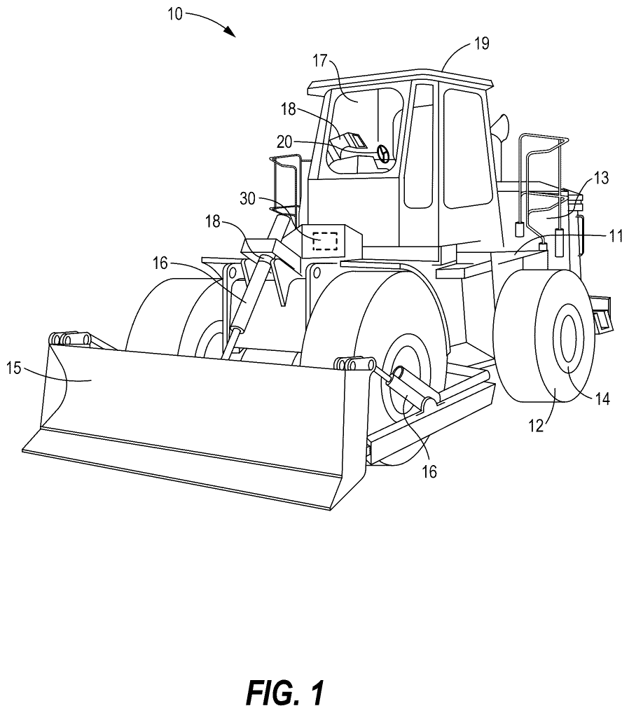

Referring now to the drawings, and with specific reference to FIG. 1, a machine is depicted and generally referred to using reference numeral 10. The machine 10 is exemplarily embodied in the form of a work machine, and more specifically a bulldozer. While the machine 10 is depicted as a bulldozer, it should be noted that a type of machine used is merely exemplary and illustrative in nature. It will be acknowledged that the teachings of the present disclosure can be similarly applied to other types of work machines including but not limited to off highway trucks, excavators, loaders, mining vehicles, and other types of machines requiring precise spatial positioning known to persons skilled in the art.

Work machines, and specifically bulldozers, may be used to in the earth moving field to cut a ground surface, and subsequently transport and deposit dirt from the cut ground surface from one spot to another on rough terrain. The machine 10 is supported by a frame 11. The machine 10 may include an engine 13 supported by the frame 11 for providing motive power to the machine 10. While the engine 13 is depicted as an internal combustion engine, the engine 13 may also comprise an electric motor, a hybrid powerplant system, or other power generators as known. The machine 10 may comprise a drivetrain 12 connected to the engine 13, and connected to a ground engaging member 14. In the machine 10 of FIG. 1, the ground engaging member 14 is a wheel, however, track-type system or other ground engaging members as known may be utilized.

The machine 10 may comprise an operator cabin 17 supported by the frame 11, and a controller 20 mounted within the operator cabin 17 for controlling operation of the machine 10. The machine 10 may comprise an implement 15 operatively associated with the frame 11, movable relative to the frame 11, and controlled by the controller 20. In the machine 10 of FIG. 1, the implement 15 is a blade connected to the frame 11, and further includes a hydraulic cylinder 16 for actuating the blade relative to the frame. The machine 10 may be an earth moving machine, and as such, the implement may be any one of blades, rippers, or other ground-engaging tools to cut into a ground surface 50.

The machine 10 may comprise an imaging device 30 mounted to the machine 10. The imaging device 30 may be mounted to the frame 11 of the machine 10, may be mounted within the operator cabin 17 of the machine 10, or may be mounted anywhere on the machine 10 as required. The imaging device 30 may be configured to interact with a target 40 of a spatial localization imaging system 60, and deliver target data derived from the target 40 to the controller 20. The controller 20 may be configured to interpret the target data to calculate a map of a site 61 the machine 10 is operating on, provide a real-time estimate of a location of the machine 10 within the site 61, and provide an automated input for the implement 15.

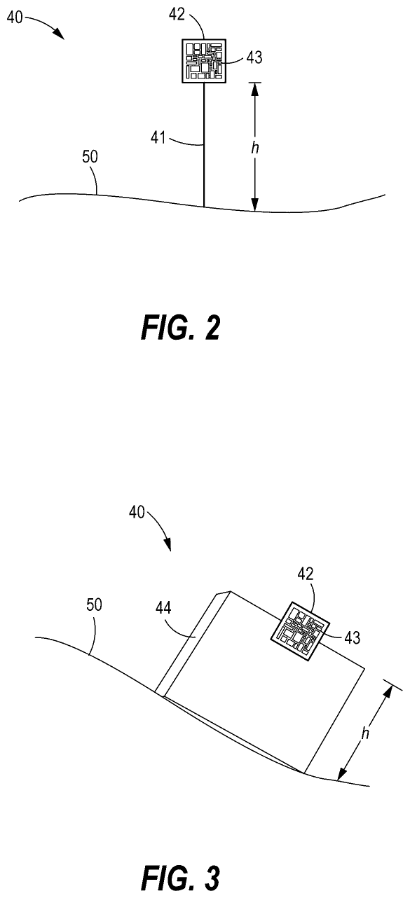

FIGS. 2-3 depict an exemplary form of the target 40 of the spatial localization imaging system 60. In an exemplary embodiment, the imaging device 30 of the machine 10 may be a camera configured to read quick response (QR) codes. However, other imaging devices as known may be utilized to read corresponding target coding forms. The target 40 may be a fiducial target. As best understood, the term “fiducial” refers to the target 40 taken as a standard of reference. Accordingly, the target 40 may include a sign 42 bearing a QR code 43 on a signpost 41. The QR code 43 may include the target data to be interpreted by the controller 20. The target data may be simple, bearing only a numerical identifier to the target, or may include as complex of information as required. The target data may include two-dimensional spatial information of the target 40 relative to a reference point, and may also include three-dimensional spatial information of the target 40 relative to the reference point. As shown in FIG. 2, the sign 42 and the signpost 41 are oriented in the ground surface 50 such that a standard height h exists between the sign 42 and the ground surface 50. Thus, a plurality of the target 40 are placed around the site 61, each extending the standard height h above an instant ground surface, such that the controller 20 can interpret a change in height of the ground surface 50 from one of the target 40 to another. FIG. 3 depicts the target 40 once again as the sign 42 bearing the QR code 43, but oriented on a bracket 44. The bracket 44 allows for the sign 42 to maintain the standard height h above the ground surface 50 when the surface is sloped, as depicted in FIG. 3.

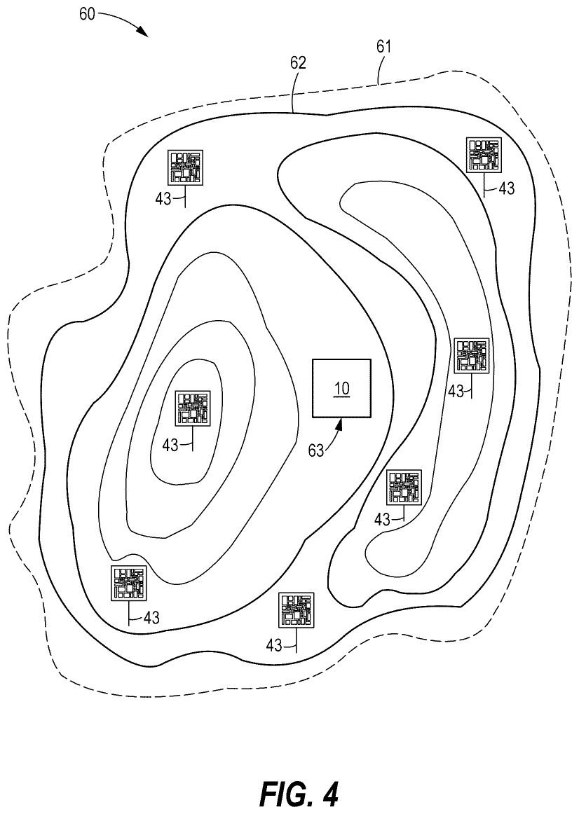

FIG. 4 depicts the spatial localization imaging system 60 in operation on a site 61. The spatial localization imaging system 60 allows the machine 10 to accurately position itself in six axes. FIG. 4 is shown as a topographical map with contour lines 62 indicating changes in elevation on the site 61. A plurality of the target 40 may be placed throughout the site 61 such that changes in the elevation of the site 61 can properly be observed by the imaging device 30 and interpreted by the controller 20. The machine 10 is placed at an origin 63 on the site 61 such that the machine 10 can have a reference point to begin performing a job.

The machine 10 may include additional sensors to assist the controller 20 with providing the real-time estimate of the location of the machine 10 on the site 61 by augmenting the real-time estimate. The sensor 18 may be mounted to the frame of the machine 10 to read operational data of the machine 10. The sensor 18 may communicate with a radio 19 in order to receive the operational data. For example, the sensor 18 may include an inertial measurement unit configured to measure orientation relative to gravity and/or rotational motion of the machine 10 while in operation. The sensor 18 may also include a distance sensor within the hydraulic cylinder 16 connected to the implement 15. The distance sensor may be configured to measure an actuation distance or a displacement of the hydraulic cylinder 16, and therefore determine a spatial location of the implement 15 relative to the frame 11 of the machine 10. The sensor 18 may also include a global positioning sensor such that an instant positioning of the machine 10 may be ascertained using GPS coordinates.

### INDUSTRIAL APPLICABILITY

In operation, the teachings of the present disclosure can find applicability in many industries including but not limited to work machines used in the earth moving, mining, agricultural, and construction industries. While depicted and described in conjunction with a bulldozer, such teachings can also find applicability with other machines such as off highway trucks, excavators, loaders, mining vehicles, and other types of machines requiring precise spatial positioning known to persons skilled in the art.

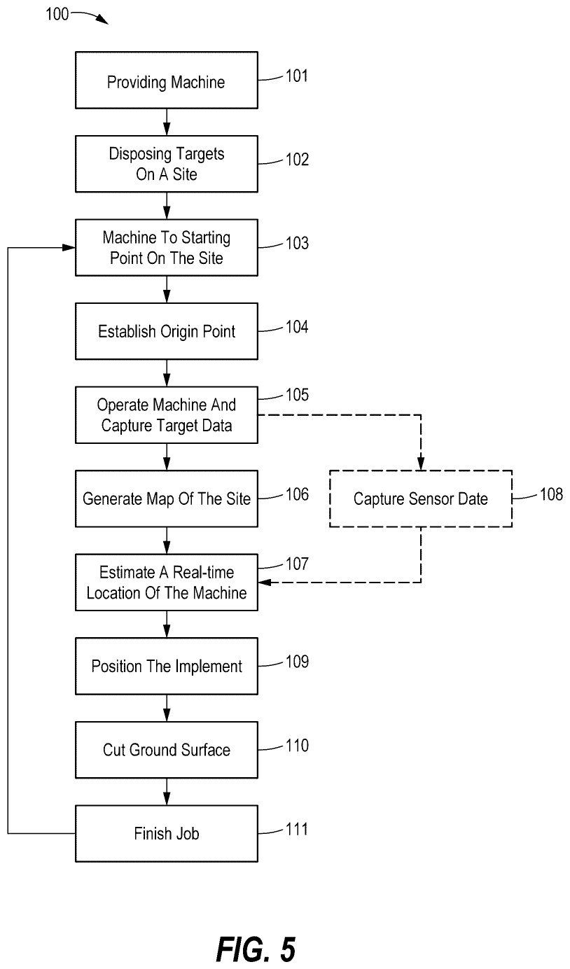

FIG. 5 illustrates a visual representation of a method 100 of spatial localization of the machine 10 on the site 61. In a first step 101, the machine 10 is provided. Providing the machine 10 includes providing the frame 11, the implement 15 attached to the frame 11 and movable relative to the frame 11, the operator cabin 17 supported by the frame 11, and the controller 20 mounted within the operator cabin 17 for controlling operation of the machine 10. Providing the machine 10 also includes providing the imaging device 30 mounted to the machine 10 and configured to communicate with the controller 20.

In a second step 102, the site 61 is provided with the target 40, which is configured to interact with the imaging device 30. As shown in the example of FIG. 4, the plurality of the target 40 are provided at various points on the site 61 such that variations in topography of the site 61 can be accurately mapped. In order to create the reference point, in a third step 103, the machine 10 is operated to the starting point on the site, and in a fourth step 104, the operator commands the controller 20 to establish the origin 63.

The machine 10 is then operated, and in the process, captures target data of the target 40 through interaction with the imaging device 30. In a fifth step 105, imaging device 30 captures the target data and sends the target data to the controller 20. The controller 20 receives the target data captured from the imaging device 30 and interprets the target data. In a sixth step 106, the controller 20 generates a map of the site 61 using the target data as a reference. The controller 20 then can provide an estimate, in real-time, of the location of the machine 10 as it is operating on the site 61, based on the map, in a seventh step 107. Optionally, the machine 10 may be equipped with additional sensors, and in an eighth step 108, the controller 20 captures additional sensor data. The controller 20 then may augment the real-time location of the machine based on the additional sensor data.

Once the real-time location of the machine 10 is provided, the controller 20 may then automate a position of the implement 15 relative to the frame 11, in a ninth step 109. The automation may include lowering the implement 15 to a fixed depth below the ground surface 50, and in a tenth step 110, may include cutting to a specific profile relative to the origin 63. However, the automation may include other earth-shaping techniques. Finally, in an eleventh step 111, the machine 10 finishes its job, and the implement 15 is returned to a neutral position.

The method 100 can be adapted to any machine 10, requiring only the installation of the imaging device 30, a sensor installation, and a software update to retrofit. The method 100 can also be adapted to other industries and any machine requiring precise spatial positioning while in operation.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A machine, comprising:
a frame;
an engine supported by the frame;
a drivetrain connected to the engine, the drivetrain connected to a ground-engaging member;
an operator cabin supported by the frame;
a controller mounted within the operator cabin for controlling operation of the machine;
an implement operatively associated with the frame, the implement movable relative to the frame and controlled by the controller; and
an imaging device mounted to the machine, the imaging device configured to interact with a target of a spatial localization imaging system and deliver target data to the controller, the controller configured to interpret the target data to calculate a map of a site the machine is operating on, provide a real-time estimate of a location of the machine within the site, and provide an automated input for the implement.

2. The machine of claim 1, further comprising a sensor mounted to the frame, the sensor configured to communicate with the controller and provide an additional estimate of the location of the machine within the site such that the additional estimate augments the real-time estimate.

3. The machine of claim 2, wherein the sensor is an inertial measurement unit configured to measure orientation of the machine while in operation.

4. The machine of claim 2, further comprising:
a hydraulic cylinder connecting the frame and the implement, configured to provide motive force to the implement;
the sensor being a distance sensor configured to measure an actuation distance of the hydraulic cylinder.

5. The machine of claim 2, further comprising a global positioning system (GPS) mounted to the frame of the machine, wherein the sensor is a global positioning sensor.

6. The machine of claim 1, wherein the implement is a ground-engaging tool configured to cut a ground surface proximate the machine.

7. A spatial localization imaging system for a machine, comprising:
an imaging device mounted to the machine;
a target configured to interact with the imaging device; and
a controller operatively connected to an implement of the machine, the controller configured to receive target data from the imaging device, interpret the target data to calculate a map of a site the machine is operating on, provide a real-time estimate of a location of the machine within the site, and provide an automated input for the implement.

8. The spatial localization imaging system of claim 7, further comprising a sensor mounted to the machine, the sensor configured to communicate with the controller and provide an additional estimate of the location of the machine within the site such that the additional estimate augments the real-time estimate.

9. The spatial localization imaging system of claim 8, wherein the sensor is an inertial measurement unit.

10. The spatial localization imaging system of claim 8, wherein the implement includes a hydraulic cylinder, and the sensor is a distance sensor configured to measure an actuation distance of the hydraulic cylinder.

11. The spatial localization imaging system of claim 8, wherein the sensor is a global positioning sensor.

12. The spatial localization imaging system of claim 7, wherein the imaging device is a camera, and the target is a signpost containing a quick response (QR) code configured to be read by the camera.

13. The spatial localization imaging system of claim 7, wherein the target data further comprises two-dimensional spatial information of the target relative to an origin.

14. The spatial localization imaging system of claim 7, wherein the target data further comprises three-dimensional spatial information of the target relative to an origin.

15. A method of spatial localization of a machine on a site, comprising:
providing the machine including a frame, an implement attached to the frame and movable relative to the frame, an operator cabin supported by the frame, and a controller mounted within the operator cabin for controlling operation of the machine;
providing an imaging device mounted to the machine and configured to communicate with the controller;
providing the site with a target configured to interact with the imaging device;
operating the machine to a starting point on the site;
commanding establishment of an origin through the controller;
capturing a target data of the target through interaction with the imaging device and sending the target data from the imaging device to the controller;
generating a map of the site;
estimating a real-time location of the machine on the site, based on the map; and
automating a positioning of the implement relative to the frame.

16. The method of claim 15, wherein the implement is a ground-engaging tool, and the step of automating a positioning of the implement further comprises positioning the ground-engaging tool at a fixed depth relative to a ground surface of the origin.

17. The method of claim 16, further comprising cutting the ground surface with the ground-engaging tool at the fixed depth.

18. The method of claim 15, further comprising:
providing an inertial measurement unit mounted to the machine;
capturing an inertial measurement of the machine using the inertial measurement unit;
sending the inertial measurement to the controller; and
augmenting the real-time location of the machine based on the inertial measurement.

19. The method of claim 15, further comprising:
providing the implement with a hydraulic cylinder for actuating the implement including a distance sensor within the hydraulic cylinder for measuring an actuation distance of the hydraulic cylinder;
capturing the actuation distance of the hydraulic cylinder using the distance sensor;
sending the actuation distance to the controller; and
augmenting the real-time location of the machine based on the actuation distance.

20. The method of claim 15, further comprising:
providing a global positioning sensor mounted to the machine;
capturing an instant positioning of the machine using the global positioning sensor;
sending the instant positioning to the controller; and
augmenting the real-time location of the machine based on the instant positioning.
